(19) United States
(12) Patent Application Publication
(10) Pub. No.: US 2022/0366522 A1
(43) Pub. Date: Nov. 17, 2022

(54) ELECTRONIC DEVICE

(71) Applicant: SONY SEMICONDUCTOR SOLUTIONS CORPORATION, KANAGAWA (JP)

(72) Inventors: TOSHIKI ITAGAKI, KANAGAWA (JP); TAKASHI MIYAMOTO, KANAGAWA (JP); NOBUO NAKAMURA, KANAGAWA (JP)

(21) Appl. No.: 17/771,357

(22) PCT Filed: Jul. 17, 2020
(86) PCT No.: PCT/JP2020/027750

§ 371 Date: Apr. 22, 2022

(30) Foreign Application Priority Data
Oct. 30, 2019 (JP) 2019-196839

(51) Int. Cl. G06T 1/00

(52) U.S. Cl. CPC G06T 1/0057; G06T 1/0042; G06T 2201/0053

(57) ABSTRACT

In an electronic device that embeds information in content, copyright protection and prevention of falsification are achieved at the same time. The electronic device includes a content generation unit, a first embedding processing unit, and a second embedding processing unit. In this electronic device, the content generation unit generates content. Furthermore, in the electronic device, the first embedding processing unit embeds, in the content, first embedded information related to the content. The second embedding processing unit embeds second embedded information in the content.

### TECHNICAL FIELD

The present technology relates to an electronic device. Specifically, the present technology relates to an electronic device that processes content.

### BACKGROUND ART

In electronic devices that process content such as images and sounds, an embedding technology called information hiding has conventionally been widely used for the purpose of copyright management or the like. Information embedded in this information hiding is roughly divided into digital watermark and steganography. Of these, digital watermark is information that is to be read by a receiving side in relation to content to be embedded, and includes copyright information. On the other hand, steganography is information that is to be kept secret and is not always related to the content, and includes encrypted information. For example, an electronic device that embeds a digital watermark indicating copyright information in raw image data has been proposed (see, for example, Patent Document 1). In a case where copyright information is embedded in this way, a digital watermark that is highly resistant to attacks such as compression, editing, and processing is often used so that the copyright information is not lost, and such a digital watermark is called a robust digital watermark.

### CITATION LIST

### Patent Document

Patent Document 1: Japanese Patent Application Laid-Open No. 2005-278099

### SUMMARY OF THE INVENTION

### Problems to be Solved by the Invention

The above-described conventional technology protects copyright by embedding of a robust digital watermark that indicates copyright information. However, in a case where a robust digital watermark is used, it becomes difficult to determine whether there has been an act of falsification of content. Determination of whether there has been an act of falsification can be achieved by lowering robustness of the digital watermark. However, lowering the robustness causes the copyright information to be likely to be lost. As described above, the above-described electronic device has a problem in that it is difficult to achieve copyright protection and prevention of falsification at the same time.

The present technology has been created in view of such a situation, and is aimed at achieving copyright protection and prevention of falsification at the same time in an electronic device that embeds information in content.

### Solutions to Problems

The present technology has been made to solve the above-described problems, and a first aspect thereof provides an electronic device including: a content generation unit that generates content; a first embedding processing unit that embeds, in the content, first embedded information related to the content; and second embedding processing that embeds second embedded information in the content. This has the effect of easily achieving copyright protection and prevention of falsification.

Furthermore, in the first aspect, the first embedded information and the second embedded information may be digital watermark information. This has the effect of facilitating adjustment of robustness of the digital watermark information.

Furthermore, in the first aspect, the first embedded information and the second embedded information may differ in robustness. This has the effect of facilitating adjustment of the robustness of the embedded information.

Furthermore, in the first aspect, the robustness of the first embedded information may be higher than the robustness of the second embedded information. This has the effect of facilitating adjustment of the robustness of the embedded information.

Furthermore, in the first aspect, the second embedding processing unit may embed the second embedded information in the content in which the first embedded information has been embedded. This has the effect of preventing loss of the second embedded information due to the embedding of the first embedded information.

Furthermore, in the first aspect, an image processing unit that executes predetermined image processing on the content in which the first embedded information has been embedded may be further included, and the second embedding processing unit may embed the second embedded information in the content on which the image processing has been executed. This has the effect of preventing loss of the second embedded information due to the image processing.

Furthermore, in the first aspect, the content may be image data, and the image processing may include demosaic processing. This has the effect of preventing loss of the second embedded information due to the demosaic processing.

Furthermore, in the first aspect, the image processing may include compression processing. This has the effect of preventing loss of the second embedded information due to the compression processing.

Furthermore, in the first aspect, the first embedded information may be robust digital watermark information or semi-fragile digital watermark information, and the second embedded information may be semi-fragile digital watermark information or fragile digital watermark information. This has the effect of determining whether there has been an act of falsification while protecting the copyright.

Furthermore, in the first aspect, the content may be image data that includes a first pixel region and a second pixel region, the first embedded information may be embedded in the first pixel region, the second embedded information may be embedded in a region corresponding to the second pixel region in the image data after the image processing, and the first pixel region and the second pixel region may not overlap. This has the effect of improving an image quality of the image data.

Furthermore, in the first aspect, the image processing may include compression processing. This has the effect of preventing loss of the second embedded information due to the compression processing.

Furthermore, in the first aspect, the content may be image data that includes a first pixel region and a second pixel region, the first embedded information may be embedded in the first pixel region, the second embedded information may be embedded in a region corresponding to the second pixel region in the image data after the image processing, and the first pixel region and the second pixel region may at least partially overlap. This has the effect of making the digital watermark information less likely to be lost even in a case where a part of the image is attacked.

Furthermore, in the first aspect, the image processing may include compression processing. This has the effect of preventing loss of the second embedded information due to the compression processing.

Furthermore, in the first aspect, the first embedded information may include information related to the second embedded information. This has the effect of facilitating reading of the second embedded information.

Furthermore, in the first aspect, the second embedded information may be encrypted non-digital watermark information. This has the effect of improving security.

Furthermore, in the first aspect, the content may be an image file that includes image data and non-image data, and the second embedded information may be embedded in the non-image data. This has the effect of preventing deterioration in image quality of the image data.

Furthermore, in the first aspect, the second embedded information may be information related to a digital signature. This has the effect of improving security.

Furthermore, in the first aspect, the first embedded information may include information related to the second embedded information. This has the effect of facilitating reading of the second embedded information.

Furthermore, in the first aspect, the second embedded information may include information related to the first embedded information. This has the effect of facilitating reading of the first embedded information.

Furthermore, in the first aspect, the first embedded information may include copyright information. This has the effect of protecting the copyright.

### BRIEF DESCRIPTION OF DRAWINGS

FIG. 1 is a block diagram illustrating a configuration example of a communication system according to a first embodiment of the present technology.

FIG. 2 is a block diagram illustrating a configuration example of an imaging device according to the first embodiment of the present technology.

FIG. 3 is a block diagram illustrating a configuration example of an imaging element according to the first embodiment of the present technology.

FIG. 4 is a circuit diagram illustrating a configuration example of a pixel according to the first embodiment of the present technology.

FIG. 5 is an example of a sectional view of the pixel according to the first embodiment of the present technology.

FIG. 6 is a block diagram illustrating a configuration example of an application processor according to the first embodiment of the present technology.

FIG. 7 is a diagram illustrating an example of disposing a first pixel region and a second pixel region according to the first embodiment of the present technology.

FIG. 8 is a diagram illustrating another example of disposing the first pixel region and the second pixel region according to the first embodiment of the present technology.

FIG. 9 is a block diagram illustrating a configuration example of a first digital watermark information embedding unit according to the first embodiment of the present technology.

FIG. 10 is a block diagram illustrating a configuration example of a first digital watermark information creation unit according to the first embodiment of the present technology.

FIG. 11 is a block diagram illustrating a configuration example of a digital watermark embedding unit according to the first embodiment of the present technology.

FIG. 12 is a block diagram illustrating a configuration example of a second digital watermark information embedding unit according to the first embodiment of the present technology.

FIG. 13 is a block diagram illustrating a configuration example of a second digital watermark information creation unit according to the first embodiment of the present technology.

FIG. 14 is a block diagram illustrating a configuration example of a server according to the first embodiment of the present technology.

FIG. 15 is a flowchart illustrating an example of operation of an electronic device according to the first embodiment of the present technology.

FIG. 16 is a flowchart illustrating an example of operation of the electronic device according to a first modified example of the first embodiment of the present technology.

FIG. 17 is a flowchart illustrating an example of operation of the electronic device according to a second modified example of the first embodiment of the present technology.

FIG. 18 is a flowchart illustrating an example of operation of the electronic device according to a third modified example of the first embodiment of the present technology.

FIG. 19 is a flowchart illustrating an example of operation of the electronic device according to a fourth modified example of the first embodiment of the present technology.

FIG. 20 is a flowchart illustrating an example of operation of the electronic device according to a fifth modified example of the first embodiment of the present technology.

FIG. 21 is a flowchart illustrating an example of operation of the electronic device according to a sixth modified example of the first embodiment of the present technology.

FIG. 22 is a flowchart illustrating an example of operation of the electronic device according to a seventh modified example of the first embodiment of the present technology.

FIG. 23 is a flowchart illustrating an example of operation of the electronic device according to an eighth modified example of the first embodiment of the present technology.

FIG. 24 is a flowchart illustrating an example of operation of the electronic device according to a ninth modified example of the first embodiment of the present technology.

FIG. 25 is a flowchart illustrating an example of operation of an electronic device according to a second embodiment of the present technology.

### MODE FOR CARRYING OUT THE INVENTION

Modes for carrying out the present technology (hereinafter referred to as “embodiments”) will be described below. The description will be made in the following order.

1. First embodiment (example of embedding two pieces of digital watermark information)

2. Second embodiment (example of embedding digital watermark information and digital signature)

### 1. First Embodiment

[Configuration Example of Communication System]

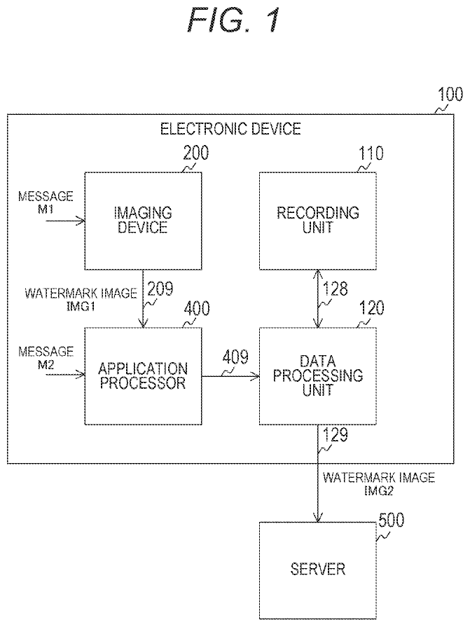

FIG. 1 is a block diagram illustrating a configuration example of a communication system according to a first embodiment of the present technology. This communication system is a system for transmitting and receiving content, and includes an electronic device 100 and a server 500.

The electronic device 100 performs processing of embedding digital watermark information in the content. The electronic device 100 includes an imaging device 200, an application processor 400, a recording unit 110, and a data processing unit 120.

The imaging device 200 captures an image as content. The image that has just been captured is not embedded with digital watermark information, and an image in this state is hereinafter referred to as an “original image”. Furthermore, a message M1 that contains copyright information is input to the imaging device 200 in advance. As this copyright information, for example, a user's name of the imaging device 200 is used. The imaging device 200 creates digital watermark information as first digital watermark information from the message M1, and embeds the digital watermark information in the original image. An image embedded with digital watermark information is hereinafter referred to as a “watermark image”. The imaging device 200 supplies, to the application processor 400 via a signal line 209, the watermark image embedded with the first digital watermark information as a watermark image IMG1.

The application processor 400 performs predetermined image processing on the watermark image IMG1. Furthermore, the application processor 400 creates second digital watermark information from a message M2 that has been set in advance, and embeds the second digital watermark information in the watermark image IMG1 after the image processing. This message M2 is used, for example, as input data for a hash function. The application processor 400 supplies, to the data processing unit 120 via a signal line 409, the watermark image embedded with the second digital watermark information as a watermark image IMG2.

Here, it is desirable that the first digital watermark information be higher in the robustness than the second digital watermark information embedded thereafter. The robustness is resistance to attacks such as compression, editing, and processing. Digital watermark information with relatively high robustness is called robust digital watermark information, and digital watermark information with relatively low robustness is called fragile digital watermark information. Furthermore, digital watermark information that is lower in the robustness than robust digital watermark information and higher in the robustness than fragile digital watermark information is called semi-fragile digital watermark information.

For verification of robustness, for example, the Information Hiding and its. Criteria for evaluation (IHC evaluation criteria) of the IHC committee is used. Digital watermark information that is not lost by a predetermined level of attack described in this IHC evaluation criteria is determined to be robust digital watermark information. Alternatively, the industry standard attack tool StirMark can be used instead of the IHC evaluation criteria.

As the first digital watermark information, for example, robust digital watermark information or semi-fragile digital watermark information can be used. In a case where the first digital watermark information is robust digital watermark information, it is desirable to use semi-fragile digital watermark information or fragile digital watermark information as the second digital watermark information. On the other hand, in a case where the first digital watermark information is semi-fragile digital watermark information, it is desirable to use fragile digital watermark information as the second digital watermark information. Furthermore, semi-fragile digital watermark information includes a plurality of schemes that differ in the robustness. Thus, in a case where the first digital watermark information is semi-fragile digital watermark information, semi-fragile digital watermark information having lower robustness can be used as the second digital watermark information.

As described previously, increasing the robustness makes it possible to prevent the digital watermark information from being lost even in a case where the image is attacked (compressed, processed, or the like). Thus, the copyright and the like can be protected. On the other hand, reducing the robustness causes the digital watermark information to be likely to be lost when the image is attacked. Thus, in a case where the robustness is low, the communication system can determine whether or not the image has been intentionally or negligently subjected to undesirable processing (so-called an act of falsification).

In a case where there is only one type of digital watermark information, increasing the robustness makes it difficult to determine whether a falsification has been made, and reducing the robustness makes it difficult to protect the copyright. Thus, it becomes difficult to adjust the robustness. However, in the communication system, the first digital watermark information and the second digital watermark information that differ in the robustness are embedded, and this makes it possible to determine whether there has been an act of falsification while protecting the copyright.

Furthermore, in a case where the first digital watermark information is embedded after the second digital watermark information has been embedded, there is a possibility that the second digital watermark information, which is fragile, may be lost due to the embedding of the first digital watermark information. Thus, the second digital watermark information is embedded after the first digital watermark information, which is more robust, has been embedded.

The data processing unit 120 accesses the recording unit 110 via a signal line 128, and stores image data of the watermark image IMG2. Furthermore, the data processing unit 120 transmits the watermark image IMG2 to the server 500 via a signal line 129 or the Internet. The recording unit 110 records the watermark image IMG2.

The server 500 reads the first digital watermark information and the second digital watermark information from the watermark image IMG2. The server 500 uses the first digital watermark information to determine spoofing or the like, and uses the second digital watermark information to determine whether a falsification has been made.

Note that the electronic device 100 embeds digital watermark information, but the embedded information is not limited to digital watermark information. For example, the electronic device 100 may embed digital signature information instead of digital watermark information, as will be described later. Note that the first digital watermark information is an example of the first embedded information described in the claims, and the second digital watermark information is an example of the second embedded information described in the claims.

Furthermore, the electronic device 100 embeds information such as digital watermark information in an image, and can also embed information in content other than an image, for example, sounds or text. Note that the image data of the original image is an example of the content described in the claims.

[Configuration Example of Imaging Device]

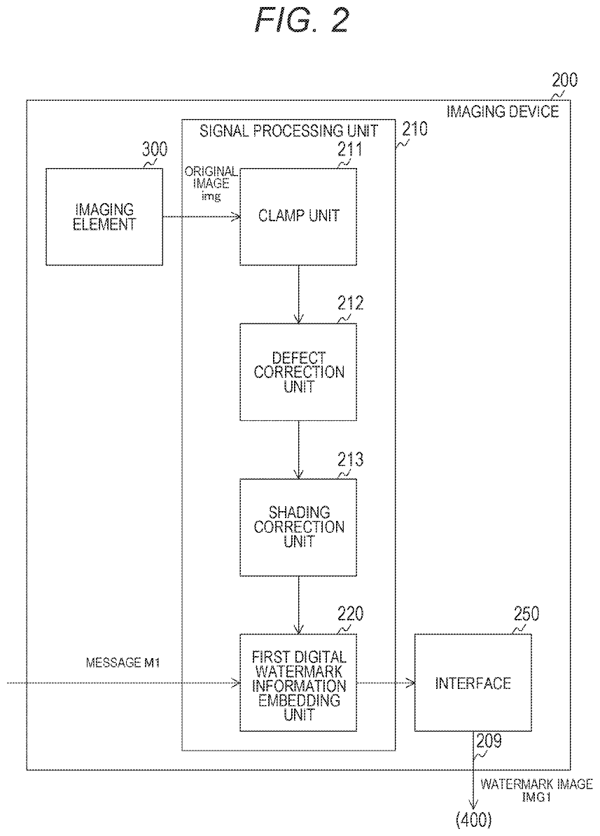

FIG. 2 is a block diagram illustrating a configuration example of the imaging device 200 according to the first embodiment of the present technology. The imaging device 200 includes an imaging element 300, a signal processing unit 210, and an interface 250.

The imaging element 300 generates an original image img. The imaging element 300 supplies image data of the original image img to the signal processing unit 210. Note that the imaging element 300 is an example of the content generation unit described in the claims.

The signal processing unit 210 performs predetermined signal processing on the original image. The signal processing unit 210 includes a clamp unit 211, a defect correction unit 212, a shading correction unit 213, and a first digital watermark information embedding unit 220.

The clamp unit 211 subtracts black level, which is a level for determining black color, from the image data of the original image img. The clamp unit 211 supplies image data obtained by subtracting the black level to the defect correction unit 212.

The defect correction unit 212 corrects a defective pixel (phase difference pixel or the like) for which a correct pixel value cannot be obtained, on the basis of the image data from the clamp unit 211. The defect correction unit 212 supplies the corrected image data to the shading correction unit 213.

The shading correction unit 213 performs shading correction for excluding luminance unevenness on the image data from the defect correction unit 212. The shading correction unit 213 supplies the image data after the shading correction to the first digital watermark information embedding unit 220.

The first digital watermark information embedding unit 220 generates the first digital watermark information from the message M1, and embeds the first digital watermark information in the image data of the original image img after the shading correction. The first digital watermark information embedding unit 220 supplies, to the application processor 400 via the interface 250, the image embedded with the first digital watermark information as the watermark image IMG1. Note that the first digital watermark information embedding unit 220 is an example of the first embedding processing unit described in the claims.

[Configuration Example of Imaging Device]

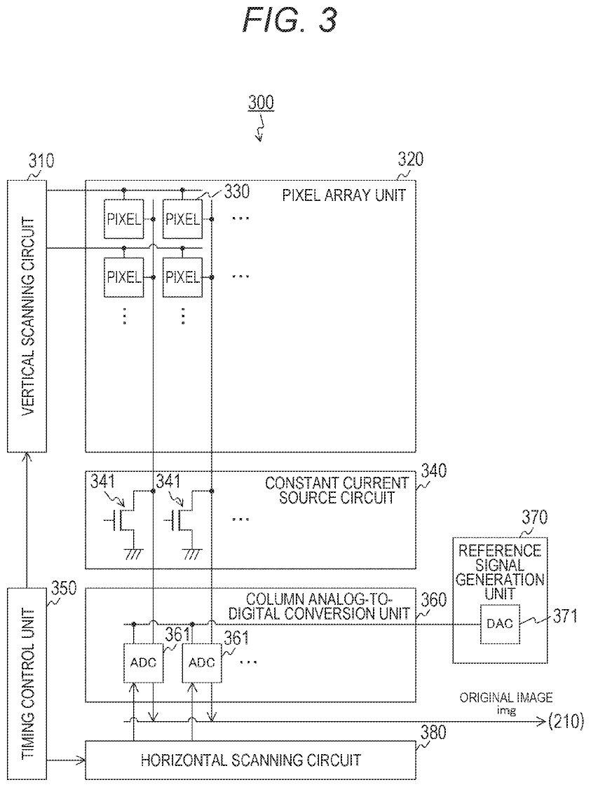

FIG. 3 is a block diagram illustrating a configuration example of the imaging element 300 according to the first embodiment of the present technology. The imaging element 300 includes a vertical scanning circuit 310, a pixel array unit 320, a constant current source circuit 340, a timing control unit 350, a column analog-to-digital conversion unit 360, a reference signal generation unit 370, and a horizontal scanning circuit 380.

A plurality of pixels 330 is arranged in a two-dimensional grid pattern in the pixel array unit 320. A set of the pixels 330 arranged in a horizontal direction is hereinafter referred to as a “row”, and a set of the pixels 330 arranged in a vertical direction is referred to as a “column”.

The vertical scanning circuit 310 sequentially drives rows to output pixel signals.

The pixels 330 generate analog pixel signals by photoelectric conversion. The pixels 330 supply the pixel signals to the column analog-to-digital conversion unit 360 via a vertical signal line.

The constant current source circuit 340 is provided with a load metal-oxide-semiconductor (MOS) 341 for each column. The load MOS 341 has a gate to which a bias voltage is applied and a source that is grounded so as to constitute a transistor and a source follower circuit in the pixels 330 of the corresponding column.

The reference signal generation unit 370 generates a sawtooth ramp signal or the like as a reference signal. The reference signal generation unit 370 includes a digital to analog converter (DAC) 371. The DAC 371 generates a reference signal by digital to analog (DA) conversion. The DAC 371 supplies the reference signal to the column analog-to-digital conversion unit 360.

The column analog-to-digital conversion unit 360 is provided with an ADC 361 for each column. The ADC 361 uses a reference signal to perform analog-to-digital conversion processing and correlated double sampling (CDS) processing on a pixel signal. The ADC 361 supplies a processed digital signal as pixel data to the signal processing unit 210 under the control of the horizontal scanning circuit 380. An image in which the pixel data is arranged corresponds to the original image img.

The horizontal scanning circuit 380 sequentially drives each of the ADCs 361 to output the pixel data.

The timing control unit 350 controls the timing at which the vertical scanning circuit 310 and the horizontal scanning circuit 380 operate.

[Configuration Example of Pixel]

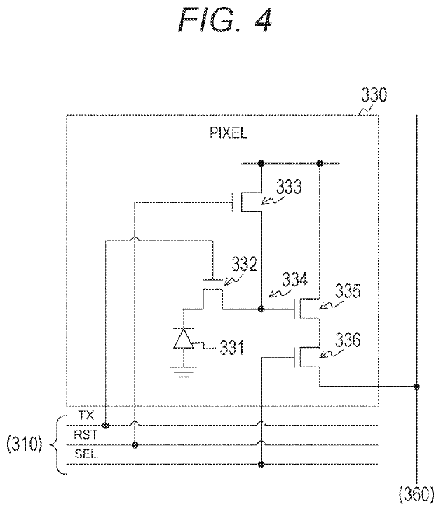

FIG. 4 is a circuit diagram illustrating a configuration example of the pixel 330 according to the first embodiment of the present technology. The pixel 330 includes a photodiode 331, a transfer transistor 332, a reset transistor 333, a floating diffusion layer 334, an amplifying transistor 335, and a selection transistor 336.

The photodiode 331 generates an electric charge by photoelectric conversion. The transfer transistor 332 transfers the electric charge from the photodiode 331 to the floating diffusion layer 334 in accordance with a transfer signal TX from the vertical scanning circuit 310.

The floating diffusion layer 334 accumulates the transferred electric charge, and generates a voltage in accordance with the amount of electric charge. The reset transistor 333 discharges the electric charge from the floating diffusion layer 334 for initialization in accordance with a reset signal RST from the vertical scanning circuit 310.

The amplifying transistor 335 amplifies the voltage from the floating diffusion layer 334. The selection transistor 336 supplies a signal of the amplified voltage as a pixel signal to the column analog-to-digital conversion unit 360 in accordance with a selection signal SEL from the vertical scanning circuit 310.

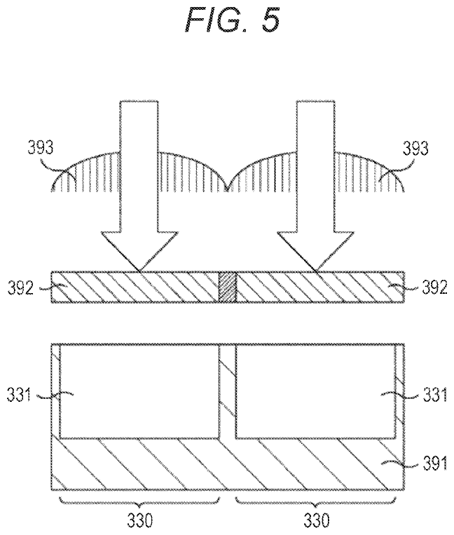

FIG. 5 is an example of a sectional view of the pixel 330 according to the first embodiment of the present technology. As illustrated in the drawing, the pixel 330 has the photodiode 331 formed on a semiconductor substrate 391. A color filter 392 is provided in a layer on top of the photodiode 331, and an on-chip lens 393 is provided in a layer on top of the color filter 392. As the color filter 392, for example, a filter that allows each of red (R) light, green (G) light, and blue (B) light to pass through is used.

[Configuration Example of Application Processor]

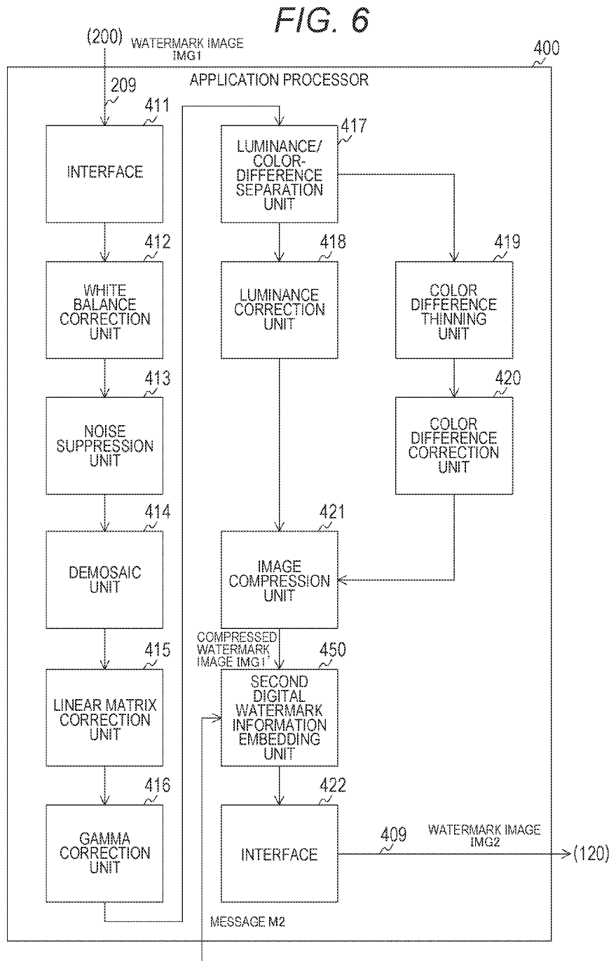

FIG. 6 is a block diagram illustrating a configuration example of the application processor 400 according to the first embodiment of the present technology. The application processor 400 includes an interface 411, a white balance correction unit 412, a noise suppression unit 413, a demosaic unit 414, a linear matrix correction unit 415, a gamma correction unit 416, and a luminance/color-difference separation unit 417. Further, the application processor 400 includes a luminance correction unit 418, a color difference thinning unit 419, a color difference correction unit 420, an image compression unit 421, a second digital watermark information embedding unit 450, and an interface 422.

The interface 411 receives image data of the watermark image IMG1 from the imaging device 200. The interface 411 supplies the received image data to the white balance correction unit 412. The image data is data before image processing such as compression processing and demosaic processing, and is generally called raw image data.

The white balance correction unit 412 corrects a white balance by controlling a gain for each of R, G, and B channels in the image data. The white balance correction unit 412 supplies the corrected image data to the noise suppression unit 413.

The noise suppression unit 413 performs processing of removing noise from the image data from the white balance correction unit 412. The noise suppression unit 413 supplies the image data after noise removal to the demosaic unit 414.

The demosaic unit 414 performs demosaic processing on the raw image data for each pixel to complement color information for any of R, G, and B that is missing. The demosaic unit 414 supplies the image data after the demosaic processing to the linear matrix correction unit 415.

The linear matrix correction unit 415 corrects information of each color of pixel data by using a matrix coefficient in order to fill a gap between a chromaticity point based on a standard and a chromaticity point of an actual camera. The linear matrix correction unit 415 supplies the corrected image data to the gamma correction unit 416.

The gamma correction unit 416 adjusts a relative relationship between the color of the image data and device characteristics on an output side to perform gamma correction in order to obtain a display closer to the original. The gamma correction unit 416 supplies the image data after the gamma correction to the luminance/color-difference separation unit 417.

The luminance/color-difference separation unit 417 separates luminance components and color difference components in the image data. The luminance/color-difference separation unit 417 supplies the luminance components to the luminance correction unit 418, and supplies the color difference components to the color difference thinning unit 419.

The luminance correction unit 418 corrects the luminance components in accordance with brightness and the like. The luminance correction unit 418 supplies the corrected luminance components to the image compression unit 421.

The color difference thinning unit thins out the color difference components of some of the pixels. The color difference thinning unit 419 supplies the color difference components after the thinning to the color difference correction unit 420. The color difference correction unit 420 corrects a color shift caused by thinning out the color difference components. The color difference correction unit 420 supplies the corrected color difference components to the image compression unit 421.

The image compression unit 421 performs compression processing on the image data in which the luminance components and the color difference components have been separated. As the compression processing, for example, compression processing in a joint photographic experts group (JPEG) format is performed. The image compression unit 421 supplies the image after the compression processing as a compressed watermark image IMG1′ to the second digital watermark information embedding unit 450.

The second digital watermark information embedding unit 450 creates second digital watermark information from the message M2, and embeds the second digital watermark information in the compressed watermark image IMG1′. The second digital watermark information embedding unit 450 supplies, to the interface 422, the image embedded with the second digital watermark information as the watermark image IMG2. Note that the second digital watermark information embedding unit 450 is an example of the second embedding processing unit described in the claims.

The interface 422 supplies the image data of the watermark image IMG2 to the data processing unit 120.

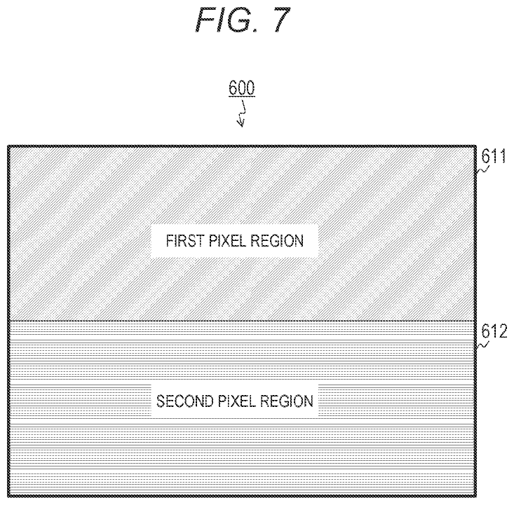

FIG. 7 is a diagram illustrating an example of disposing a first pixel region and a second pixel region according to the first embodiment of the present technology. Image data 600 of the original image img before compression processing includes a first pixel region 611 and a second pixel region 612.

The first digital watermark information is embedded in the first pixel region 611. Furthermore, a second digital watermark image is embedded in the region corresponding to the second pixel region 612 in the compressed watermark image IMG1′.

The first pixel region 611 and the second pixel region 612 do not overlap. For example, as illustrated in the drawing, the image data 600 is divided into two, one set as the first pixel region 611 and the other set as the second pixel region 612. Note that the first pixel region 611 and the second pixel region 612 may be the same or different in area. Furthermore, each of the first pixel region 611 and the second pixel region 612 has, for example, a rectangular shape. The shape is not limited to a rectangle, but may be a circle or the like.

By setting the first pixel region 611 and the second pixel region 612 so that they do not overlap, it is possible to improve the image quality of the image data. Furthermore, even in a case where an attack such as processing or trimming has been performed on one of the first pixel region 611 and the second pixel region 612, the digital watermark information in the other region is not affected. Moreover, it is possible to prevent a part of the first digital watermark information from being lost due to the processing of embedding the second digital watermark information.

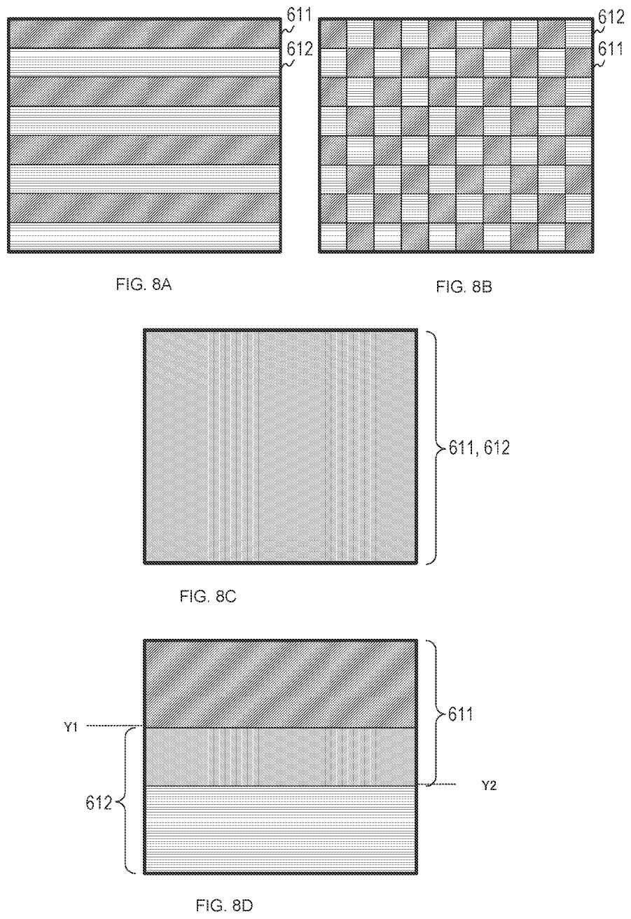

FIG. 8 is a diagram illustrating another example of disposing the first pixel region 611 and the second pixel region 612 according to the first embodiment of the present technology. In the drawing, a illustrates an example of image data in which the first pixel regions 611 and the second pixel regions 612 are alternately disposed in the column direction. In the drawing, b illustrates an example of image data in which the first pixel regions 611 and the second pixel regions 612 are alternately disposed in each of the column direction and the row direction. With this disposition, in a case where one of the first pixel regions 611 and the second pixel regions 612 are painted black and the other are painted white, a checkered flag pattern is formed. In the drawing, c illustrates an example of image data in which the entire first pixel region 611 is disposed so as to overlap with the second pixel region 612. In the drawing, d illustrates an example of image data in which the first pixel region 611 is disposed so as to partially overlap with the second pixel region 612.

As illustrated in a in the drawing, the first pixel regions 611 and the second pixel regions 612 can be alternately disposed in the column direction. Assuming that the number of rows in each of the first pixel region 611 and the second pixel region 612 is K (K is an integer), each of the imaging device 200 and the application processor 400 sequentially acquires the rows when the digital watermark is embedded, holds the K rows in a memory, and performs embedding processing. By alternately disposing the first pixel regions 611 and the second pixel regions 612 in the column direction, it is possible to decrease a capacity of the memory. Furthermore, it is possible to improve the robustness and an accuracy of determining an act of falsification in the column direction.

Furthermore, as illustrated in b in the drawing, the first pixel regions 611 and the second pixel regions 612 may be disposed alternately in each of the column direction and the row direction. With this disposition, it is possible to improve the robustness and the accuracy of determining an act of falsification in the horizontal direction and the column direction.

Furthermore, as illustrated in c in the drawing, the entire first pixel region 611 may be disposed so as to overlap with the second pixel region 612. This makes the digital watermark information less likely to be lost even in a case where a part of the image is attacked. Furthermore, it is possible to use the second digital watermark information to determine whether or not the first digital watermark information has been attacked.

Furthermore, as illustrated in d in the drawing, the first pixel region 611 may be disposed so as to partially overlap with the second pixel region 612. For example, the rows from the topmost row to a row Y2 are set as the first pixel region 611, and the rows from a row Y1, which is above Y2, to the lowermost row are set as the second pixel region 612. With the first pixel region and the second pixel region disposed so as to partially overlap, the digital watermark information is less likely to be lost even in a case where the overlapping part has been attacked. Furthermore, the image quality of non-overlapping parts can be improved. Note that an important part of an image is often positioned near the center of the image, and the overlapping portion preferably includes the central portion of the image.

[Configuration Example of First Digital Watermark Information Embedding Unit]

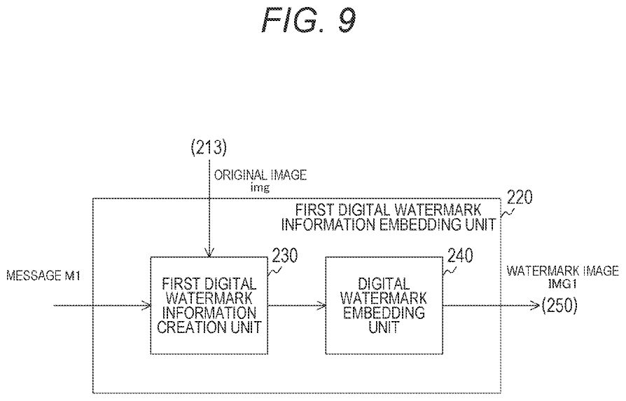

FIG. 9 is a block diagram illustrating a configuration example of the first digital watermark information embedding unit 220 according to the first embodiment of the present technology. The first digital watermark information embedding unit 220 includes a first digital watermark information creation unit 230 and a digital watermark embedding unit 240.

The first digital watermark information creation unit 230 creates first digital watermark information from the original image img from the shading correction unit 213 and the message M1. The first digital watermark information creation unit 230 supplies the created first digital watermark information to the digital watermark embedding unit 240 together with the original image img.

The digital watermark embedding unit 240 embeds the first digital watermark information in the original image img. The digital watermark embedding unit 240 supplies, to the interface 250, the image embedded with the first digital watermark information as the watermark image IMG1.

Note that the first digital watermark information embedding unit 220 embeds only the first digital watermark information, but is capable of further embedding information related to the second digital watermark information. As the information related to the second digital watermark information, for example, information for specifying the second pixel region 612 in which the second digital watermark information is embedded (coordinates of representative points in the region or the like) is embedded. Alternatively, as the information related to the second digital watermark information, information indicating the scheme of the second digital watermark information (semi-fragile, fragile, or the like) is embedded. Using these pieces of information, the server 500 can specify the region in which the second digital watermark information has been embedded, and detect whether there has been an act of falsification on the basis of the scheme.

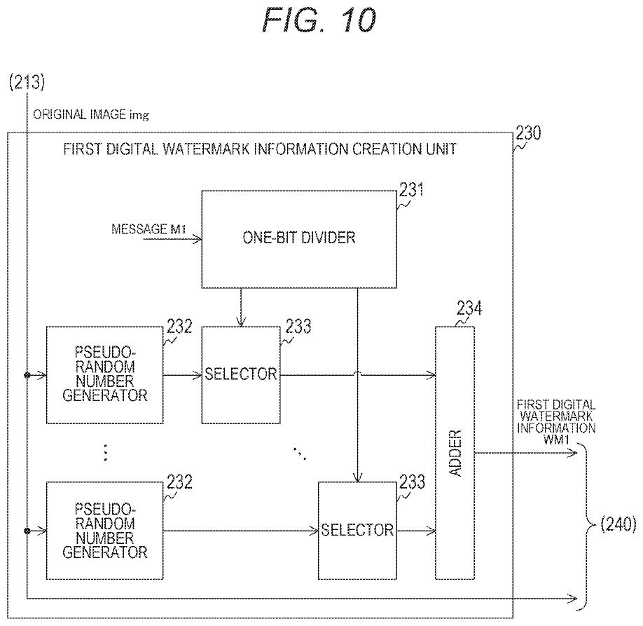

FIG. 10 is a block diagram illustrating a configuration example of the first digital watermark information creation unit 230 according to the first embodiment of the present technology. The first digital watermark information creation unit 230 includes a one-bit divider 231, a plurality of pseudo-random number generators 232, a plurality of selectors 233, and an adder 234. The pseudo-random number generators 232 and the selectors 233 are disposed, one for each bit of the message M1. In a case where a bit depth of the message M1 is L (L is an integer), L pseudo-random number generators 232 and L selectors 233 are provided.

The one-bit divider 231 divides the message M1 bit-by-bit. The one-bit divider 231 supplies each of the bits to the corresponding selector 233.

The pseudo-random number generators 232 generate pseudo-random numbers on the basis of the pixel data in the original image img. The L pseudo-random number generators 232 are input with L pieces of pixel data having different coordinates among the pixels in the pixel region 611 in the original image img. The pseudo-random number generators 232 generate pseudo-random numbers from a seed value that has been set in advance and the input pixel data, and supply the pseudo-random numbers to the corresponding selectors 233. For the generation of the pseudo-random numbers, for example, the following equation is used.

xₙ₊₁=(A·xₙ+B)mod M Equation 1

In the above equation, the left-hand side shows a generated pseudo-random number, and an initial value of xₙ corresponds to the seed value. Furthermore, M is a real number representing a range of pseudo-random numbers, and A and B are constants. For example, a value of the pixel data is set as a value of any of A, B, or n. The “mod” is a function that returns a remainder obtained by dividing (A·xₙ+B) by M. Note that the pseudo-random number generators 232 can use any mathematical formula other than Equation 1 as long as the mathematical formula can be used to generate a pseudo-random number.

The selectors 233 output pseudo-random numbers from the corresponding pseudo-random number generators 232 to the adder 234 in a case where the corresponding bit has a predetermined value (logical value “1” or the like).

The adder 234 adds the output values, one from each of the L selectors 233. The adder 234 supplies information indicating the value obtained by the addition to the digital watermark embedding unit 240 as first digital watermark information WM1. Furthermore, the original image img is also supplied to the digital watermark embedding unit 240 together with the first digital watermark information WM1.

Note that the configuration of the first digital watermark information creation unit 230 is not limited to the one illustrated in the drawing as long as the first digital watermark information WM1 can be created from the message M1.

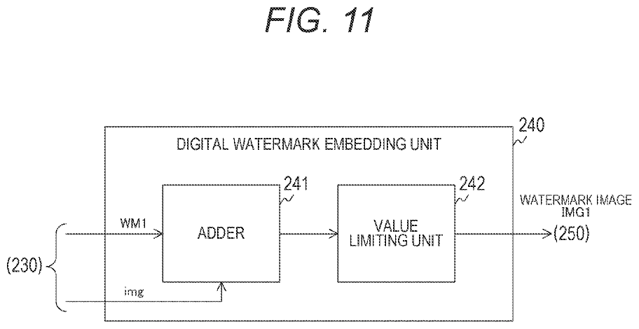

FIG. 11 is a block diagram illustrating a configuration example of the digital watermark embedding unit 240 according to the first embodiment of the present technology. The digital watermark embedding unit 240 includes an adder 241 and a value limiting unit 242.

The adder 241 adds the first digital watermark information WM1 to pixel data of a specific pixel in the first pixel region 611 in the original image img. With this arrangement, the first digital watermark information WM1 is embedded in the first pixel region 611. The adder 241 supplies the original image img after the addition to the value limiting unit 242.

The value limiting unit 242 limits the value of the pixel data to a predetermined range in the original image img after the addition. The value limiting unit 242 supplies the image after the limitation to the interface 250 as the watermark image IMG1.

Note that the configuration of the digital watermark embedding unit 240 is not limited to the configuration illustrated in the drawing as long as the digital watermark information can be embedded.

[Configuration Example of Second Digital Watermark Information Embedding Unit]

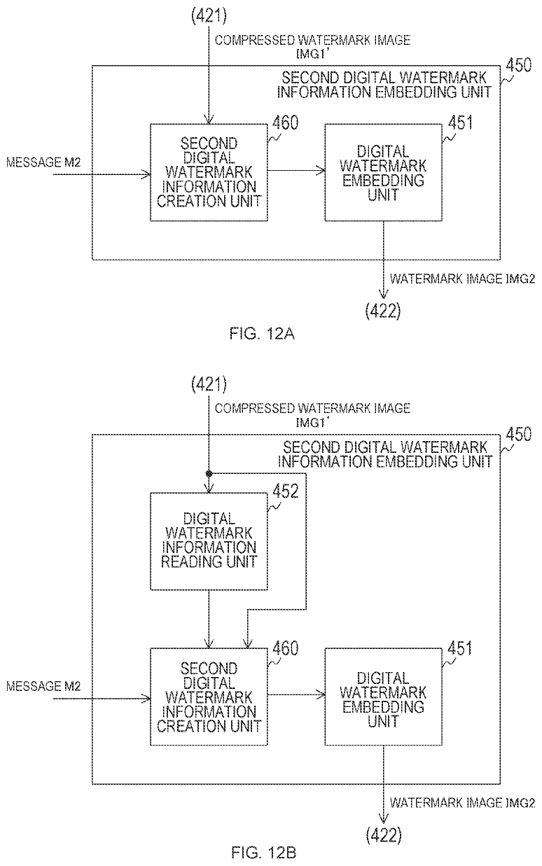

FIG. 12 is a block diagram illustrating a configuration example of the second digital watermark information embedding unit 450 according to the first embodiment of the present technology. In the drawing, a is a block diagram illustrating a configuration example of the second digital watermark information embedding unit 450 in a case where the first digital watermark information is not read. In the drawing, b is a block diagram illustrating a configuration example of the second digital watermark information embedding unit 450 in a case where the first digital watermark information is read. As illustrated in a in the drawing, in a case where the first digital watermark information is not read, the second digital watermark information embedding unit 450 includes a second digital watermark information creation unit 460 and a digital watermark embedding unit 451.

The second digital watermark information embedding unit 450 creates second digital watermark information from the compressed watermark image IMG1′ from the image compression unit 421 and the message M2. The second digital watermark information creation unit 460 supplies the created second digital watermark information to the digital watermark embedding unit 451 together with the compressed watermark image IMG1′.

The configuration of the digital watermark embedding unit 451 is similar to that of the digital watermark embedding unit 240 illustrated in FIG. 11. The digital watermark embedding unit 451 supplies, to the interface 422, the image embedded with the second digital watermark information as the watermark image IMG2.

Note that, as illustrated in b of the drawing, it is also possible to further provide a digital watermark information reading unit 452 that reads the first digital watermark information WM1, and supplies the second digital watermark information creation unit 460 with a flag that indicates the presence or absence of the first digital watermark information WM1. In this case, the second digital watermark information creation unit 460 creates second digital watermark information WM2 in a case where the first digital watermark information WM1 is present, and does not create the second digital watermark information WM2 in a case where the first digital watermark information WM1 is absent.

Furthermore, the second digital watermark embedding unit 450 embeds only the second digital watermark information WM2, but is capable of further embedding information related to the first digital watermark information WM1. As the information related to the first digital watermark information WM1, for example, information for specifying the first pixel region 611 in which the first digital watermark information WM1 is embedded (coordinates of representative points in the region or the like) is embedded. Alternatively, as the information related to the first digital watermark information WM1, information indicating the scheme of the first digital watermark information WM1 (robust, semi-fragile, or the like) is embedded. Using these pieces of information, the server 500 can specify the region in which the first digital watermark information WM1 has been embedded, and determine whether there has been an act of spoofing on the basis of the scheme.

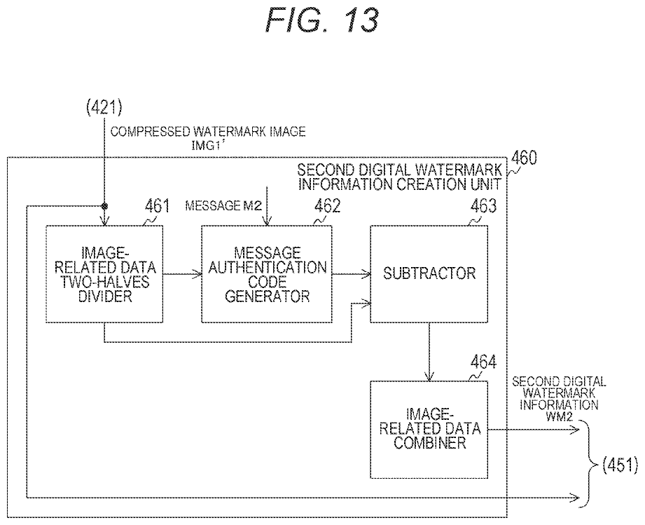

FIG. 13 is a block diagram illustrating a configuration example of the second digital watermark information creation unit 460 according to the first embodiment of the present technology. The second digital watermark information creation unit 460 includes an image-related data two-halves divider 461, a message authentication code generator 462, a subtractor 463, and an image-related data combiner 464.

The image-related data two-halves divider 461 divides pixel data of a specific pixel in the region corresponding to the second pixel region 612 in the compressed watermark image IMG1′ into two, a higher-order bit string and a lower-order bit string. The image-related data two-halves divider 461 supplies the higher-order bit string to the message authentication code generator 462, and supplies the lower-order bit string to the subtractor 463. Note that the higher-order bit string and the lower-order bit string may be the same or different in the bit depth.

The message authentication code generator 462 generates second digital watermark information on the basis of the higher-order bit string from the image-related data two-halves divider 461 and the message M2. The message authentication code generator 462 generates a message authentication code by using, for example, a predetermined hash function f(x, y). Here, the hash function f(x, y) is a function that returns a pseudo-random number in response to an input of x and y (x and y are integers). The message authentication code generator 462 inputs the message M2 as x, inputs the higher-order bit string as y, and outputs the obtained pseudo-random number as the message authentication code to the subtractor 463. It is assumed that the bit depth of a subtraction result is the same as that of the higher-order bit string, for example.

The subtractor 463 subtracts the lower-order bit string from the message authentication code. The subtractor 463 supplies the subtraction result to the image-related data combiner 464.

The image-related data combiner 464 combines the subtraction result from the subtractor 463 with a bit string in which bits of a predetermined value (logical value “0”) are arranged. It is assumed that the bit depth of the bit string to be combined is the same as that of the lower-order bit string. The image-related data combiner 464 supplies a result of the combination as the second digital watermark information WM2 to the digital watermark embedding unit 451. Furthermore, a compressed watermark image IMG2′ is also supplied to the digital watermark embedding unit 451 together with the second digital watermark information WM2.

Note that the configuration of the second digital watermark information creation unit 460 is not limited to the one illustrated in the drawing as long as the second digital watermark information WM2 can be created from the message M2.

Furthermore, the application processor 400 embeds the second digital watermark information WM2 in the image data, but the configuration is not limited to this. For example, the application processor 400 can also generate an image file that includes image data and non-image data such as metadata as content, and embed the second digital watermark information WM2 in the non-image data. By embedding the second digital watermark information WM2 in the non-image data, it is possible to prevent deterioration in image quality of the image data due to the embedding.

[Configuration Example of Server]

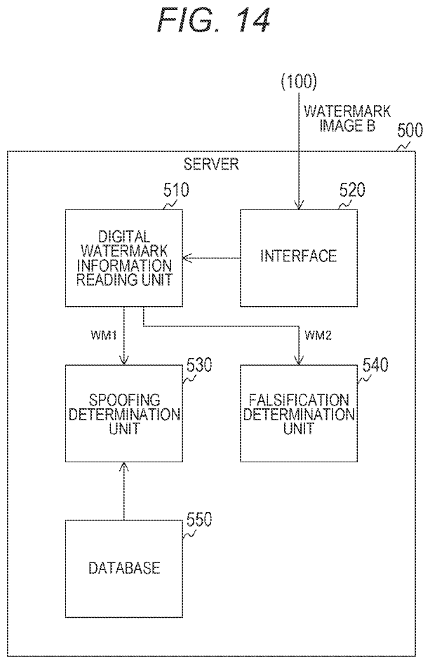

FIG. 14 is a block diagram illustrating a configuration example of the server 500 according to the first embodiment of the present technology. The server 500 includes a digital watermark information reading unit 510, an interface 520, a spoofing determination unit 530, a falsification determination unit 540, and a database 550.

The interface 520 receives the image data of the watermark image IMG2 from the electronic device 100 via the Internet or the like. The interface 520 supplies the watermark image IMG2 to the digital watermark information reading unit 510.

The digital watermark information reading unit 510 uses a method corresponding to the embedding method by the electronic device 100 to read the first digital watermark information WM1 and the second digital watermark information WM2 embedded in the watermark image IMG2. The digital watermark information reading unit 510 supplies the first digital watermark information WM1 to the spoofing determination unit 530, and supplies the second digital watermark information WM2 to the falsification determination unit 540.

The database 550 stores a predetermined number of pieces of copyright information.

The spoofing determination unit 530 uses the first digital watermark information WM1 to determine whether or not an act of spoofing has been performed. The spoofing determination unit 530 reads the pieces of copyright information from the database 550, and determines whether or not there is a piece of copyright information that matches the message M1 (that is, the copyright information) in the first digital watermark information WM1. If there is a piece of matching information, it is determined that an act of spoofing has not been performed. Then, the spoofing determination unit 530 outputs the determination result to the outside. The determination of an act of spoofing allows the copyright to be properly protected.

The falsification determination unit 540 uses the second digital watermark information WM2 to determine whether there has been an act of falsification of the watermark image IMG2. The falsification determination unit 540 determines whether the second digital watermark information WM2 has been damaged. If the second digital watermark information WM2 has been damaged, it is determined that there has been an act of falsification in the region corresponding to the second pixel region 612 in the watermark image IMG2. Then, the falsification determination unit 540 outputs the determination result to the outside.

As described above, the first digital watermark information WM1 and the second digital watermark information WM2 that differ in the robustness are embedded in the watermark image IMG2 by the electronic device 100. Thus, the server 500 can use those pieces of digital watermark information to determine whether there has been an act of falsification while protecting the copyright.

[Example of Operation of Electronic Device]

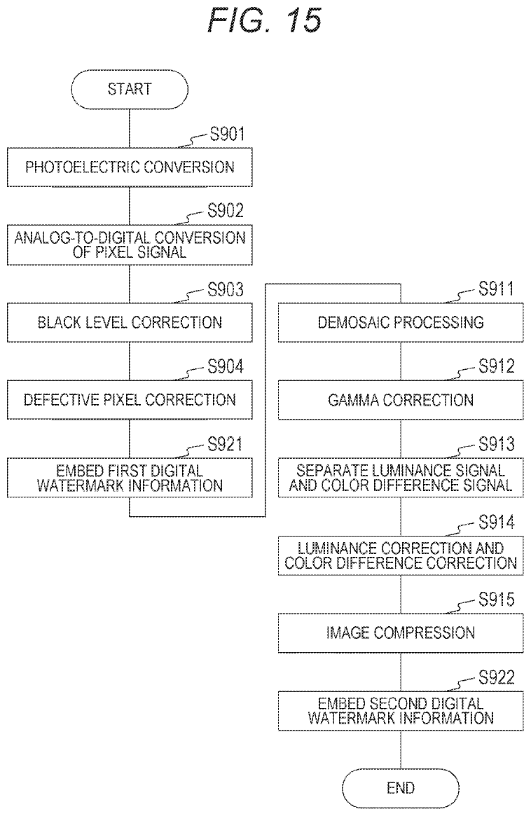

FIG. 15 is a flowchart illustrating an example of operation of the electronic device 100 according to the first embodiment of the present technology. This operation is started, for example, when a predetermined application for capturing an image has been executed.

The imaging device 200 in the electronic device 100 generates a pixel signal by photoelectric conversion (step S901), and generates pixel data by analog-to-digital conversion of the pixel signal (step S902). The imaging device 200 executes black level correction (step S903) and defective pixel correction (step S904) on the pixel data to generate an original image. Then, the imaging device 200 embeds the first digital watermark information WM1 in the original image to generate watermark image IMG1 (step S921).

Then, the application processor 400 performs demosaic processing (step S911) and gamma correction (step S912) on the watermark image IMG1. Moreover, the application processor 400 separates the luminance components and the color difference components in the image data (step S913), and then corrects the luminance components and thins out and corrects the color difference components (step S914). Then, the application processor 400 performs compression processing on the image data in which the luminance components and the color difference components have been separated (step S915), and embeds the second digital watermark information WM2 (step S922). After step S922, the electronic device 100 ends the operation for imaging.

As illustrated in the drawing, the imaging device 200 often outputs an image before demosaic (so-called raw image). Thus, the imaging device 200 embeds the first digital watermark information WM1 before demosaic, and this allows for protection of the copyright of the raw image. In a case of where the first digital watermark information WM1 is embedded before demosaic, it is necessary to use, as the first digital watermark information WM1, digital watermark information in a format that is not lost due to demosaic processing and image compression. As such digital watermark information, for example, digital watermark information embedded in a discrete cosine transform (DCT) coefficient is assumed.

Furthermore, by embedding the second digital watermark information WM2 after the compression processing of the image, it is possible to prevent the second digital watermark information WM2, which is fragile, from being lost due to the image compression.

As described above, according to the first embodiment of the present technology, the electronic device 100 embeds, in the content, the first digital watermark information related to the content together with the second digital watermark information, and this makes it possible to achieve copyright protection and prevention of falsification at the same time. For example, while protecting the copyright by embedding information regarding the copyright of the content as the first digital watermark information, it is possible to determine whether or not the embedded second digital watermark information has been lost to determine whether there has been an act of falsification.

### FIRST MODIFIED EXAMPLE

In the first embodiment described above, the application processor 400 embeds the second digital watermark information WM2 after image processing. However, this configuration does not allow the server 500 to determine whether there has been an act of falsification before image processing. The electronic device 100 in a first modified example of the first embodiment differs from that of the first embodiment in that the imaging device 200 embeds the second digital watermark information WM2.

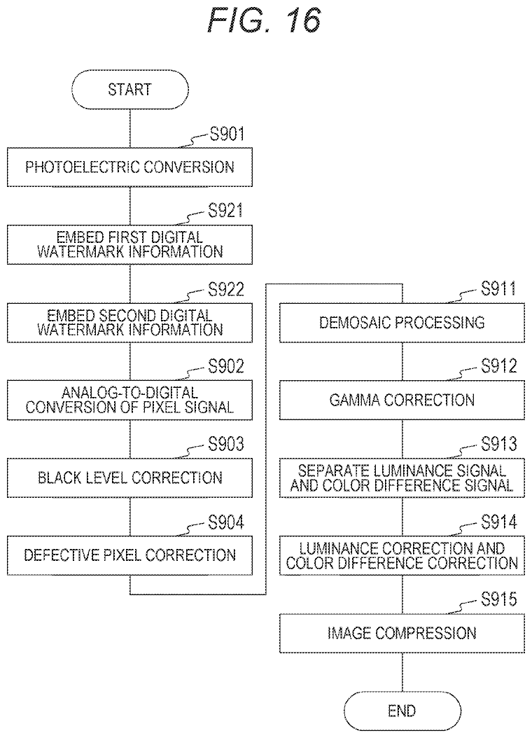

FIG. 16 is a flowchart illustrating an example of the operation of the electronic device 100 according to the first modified example of the first embodiment of the present technology. The operation of the electronic device 100 in the first modified example of the first embodiment differs from that of the first embodiment in that the digital watermark information is embedded (steps S921 and S922) before analog-to-digital conversion (step S902). The imaging device 200 embeds the first digital watermark information WM1 (step S921) in an analog pixel signal generated by photoelectric conversion (step S901), and then embeds the second digital watermark information WM2 (step S922).

As illustrated in the drawing, the imaging device 200 embeds the second digital watermark information WM2 in the analog pixel signal before image processing, and this allows the server 500 to determine whether there has been an act of falsification before the image processing.

As described above, according to the first modified example of the first embodiment of the present technology, the imaging device 200 embeds the second digital watermark information WM2 in the analog pixel signal before image processing, and this makes it possible to determine whether there has been an act of falsification before the image processing.

### SECOND MODIFIED EXAMPLE

In the first embodiment described above, the application processor 400 embeds the second digital watermark information WM2 after image processing. However, this configuration does not allow the server 500 to determine whether there has been an act of falsification before image processing. The electronic device 100 in a second modified example of the first embodiment differs from that of the first embodiment in that the imaging device 200 embeds the second digital watermark information WM2.

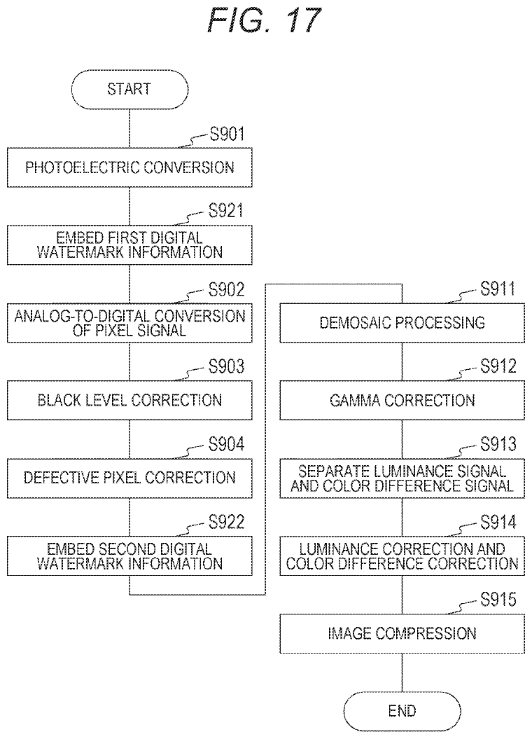

FIG. 17 is a flowchart illustrating an example of the operation of the electronic device 100 according to the second modified example of the first embodiment of the present technology. The operation of the electronic device 100 in the second modified example of the first embodiment differs from that of the first embodiment in that the digital watermark information is embedded (steps S921 and S922) before demosaic processing (step S911). The imaging device 200 embeds the first digital watermark information WM1 (step S921) in an analog pixel signal generated by photoelectric conversion (step S901). Furthermore, the imaging device 200 embeds the second digital watermark information WM2 (step S922) after defective pixel correction (step S904).

As illustrated in the drawing, the imaging device 200 embeds the second digital watermark information WM2 in pixel data after analog-to-digital conversion before image processing, and this allows the server 500 to determine whether there has been an act of falsification before the image processing.

As described above, according to the second modified example of the first embodiment of the present technology, the imaging device 200 embeds the second digital watermark information WM2 in the pixel data before image processing, and this makes it possible to determine whether there has been an act of falsification before the image processing.

### THIRD MODIFIED EXAMPLE

In the first embodiment described above, the imaging device 200 embeds the first digital watermark information WM1 after analog-to-digital conversion. Alternatively, the first digital watermark information WM1 can be embedded before the analog-to-digital conversion. Furthermore, in the first embodiment, the application processor 400 embeds the second digital watermark information WM2 after compression processing of the image, and this configuration does not allow the server 500 to determine whether there has been an act of falsification before the compression processing.

The electronic device 100 in a third modified example of the first embodiment differs from that of the first embodiment in that the first digital watermark information WM1 is embedded before analog-to-digital conversion and the second digital watermark information WM2 is embedded before compression processing.

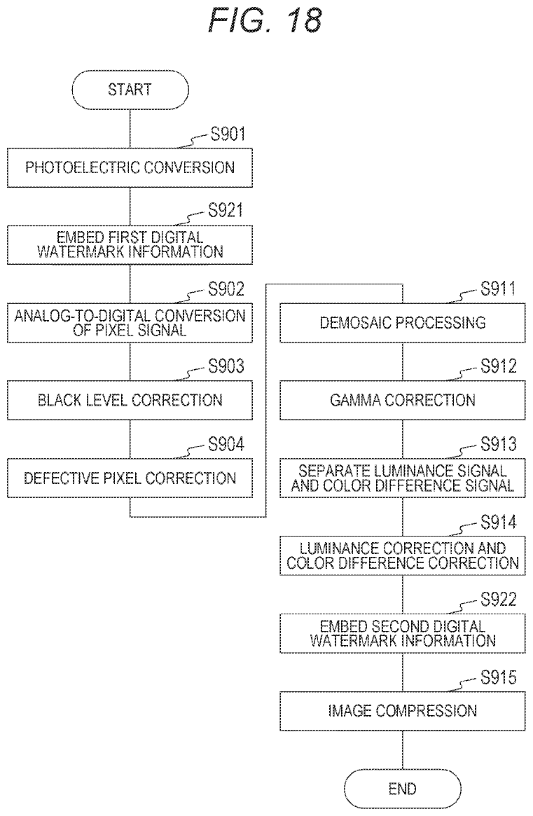

FIG. 18 is a flowchart illustrating an example of the operation of the electronic device 100 according to the third modified example of the first embodiment of the present technology. The operation of the electronic device 100 in the third modified example of the first embodiment differs from that of the first embodiment in that the first digital watermark information WM1 is embedded (step S921) before analog-to-digital conversion (step S902). Furthermore, the operation differs from that of the first embodiment in that the second digital watermark information WM2 is embedded (step S922) before image compression (step S915).

As illustrated in the drawing, the application processor 400 embeds the second digital watermark information WM2 before compression processing, and this allows the server 500 to determine whether there has been an act of falsification before the compression processing.

As described above, according to the third modified example of the first embodiment of the present technology, the application processor 400 embeds the second digital watermark information WM2 before compression processing, and this makes it possible to determine whether there has been an act of falsification before the compression processing.

### FOURTH MODIFIED EXAMPLE

In the first embodiment described above, the imaging device 200 embeds the first digital watermark information WM1 after analog-to-digital conversion. Alternatively, the first digital watermark information WM1 can be embedded before the analog-to-digital conversion. The imaging device 200 in a fourth modified example of the first embodiment differs from that of the first embodiment in that the first digital watermark information WM1 is embedded before analog-to-digital conversion.

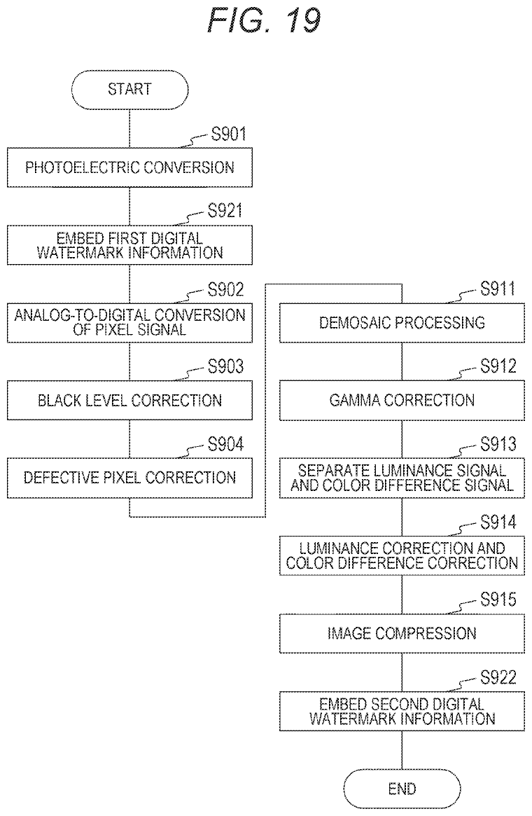

FIG. 19 is a flowchart illustrating an example of the operation of the electronic device 100 according to the fourth modified example of the first embodiment of the present technology. The operation of the electronic device 100 in the fourth modified example of the first embodiment differs from that of the first embodiment in that the first digital watermark information WM1 is embedded (step S921) before analog-to-digital conversion (step S902).

As illustrated in the drawing, the imaging device 200 embeds the first digital watermark information WM1 in an analog pixel signal before analog-to-digital conversion, and this allows for protection of the copyright of the raw image by a spoofing determination by the server 500.

As described above, according to the fourth modified example of the first embodiment of the present technology, the imaging device 200 embeds the first digital watermark information WM1 before analog-to-digital conversion, and this allows for protection of the copyright of the raw image.

### FIFTH MODIFIED EXAMPLE

In the first embodiment described above, the application processor 400 embeds the second digital watermark information WM2 after image processing. However, this configuration does not allow the server 500 to determine whether there has been an act of falsification before image processing. The electronic device 100 in a fifth modified example of the first embodiment differs from that of the first embodiment in that the imaging device 200 embeds the second digital watermark information WM2.

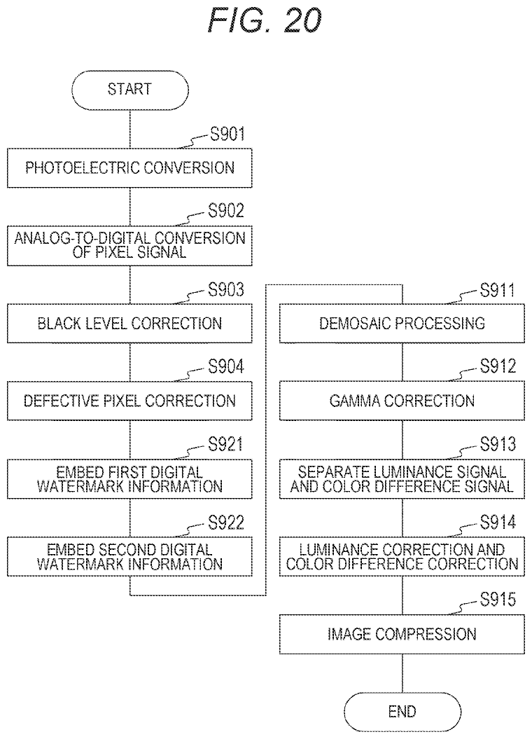

FIG. 20 is a flowchart illustrating an example of the operation of the electronic device 100 according to the fifth modified example of the first embodiment of the present technology. The operation of the electronic device 100 in the fifth modified example of the first embodiment differs from that of the first embodiment in that the digital watermark information is embedded (steps S921 and S922) after analog-to-digital conversion, for example, after correction of a defective pixel (step S904).

As illustrated in the drawing, the imaging device 200 embeds the second digital watermark information WM2 after analog-to-digital conversion, and this allows the server 500 to determine whether there has been an act of falsification before compression processing.

As described above, according to the fifth modified example of the first embodiment of the present technology, the imaging device 200 embeds the second digital watermark information WM2 after analog-to-digital conversion, and this makes it possible to determine whether there has been an act of falsification before compression processing.

### SIXTH MODIFIED EXAMPLE

In the first embodiment described above, the application processor 400 embeds the second digital watermark information WM2 after compression processing of the image. However, this configuration does not allow the server 500 to determine whether there has been an act of falsification before the compression processing. The application processor 400 in a sixth modified example of the first embodiment differs from that of the first embodiment in that the second digital watermark information WM2 is embedded before compression processing.

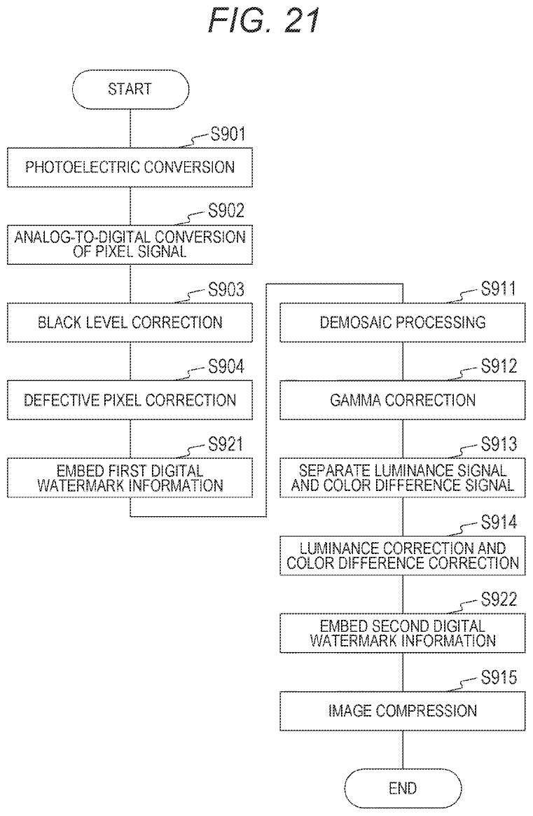

FIG. 21 is a flowchart illustrating an example of the operation of the electronic device 100 according to the sixth modified example of the first embodiment of the present technology. The operation of the electronic device 100 in the sixth modified example of the first embodiment differs from that of the first embodiment in that the second digital watermark information WM2 is embedded (step S921) before image compression (step S915).

As illustrated in the drawing, the application processor 400 embeds the second digital watermark information WM2 before compression processing, and this allows the server 500 to determine whether there has been an act of falsification before the compression processing.

As described above, according to the sixth modified example of the first embodiment of the present technology, the application processor 400 embeds the second digital watermark information WM2 before compression processing, and this makes it possible to determine whether there has been an act of falsification before the compression processing.

### SEVENTH MODIFIED EXAMPLE

In the first embodiment described above, the imaging device 200 embeds the first digital watermark information WM1 before demosaic. Alternatively, it is possible to embed the first digital watermark information WM1 after the demosaic. Furthermore, the application processor 400 embeds the second digital watermark information WM2 after image processing, and this configuration does not allow the server 500 to determine whether there has been an act of falsification before the image processing. The electronic device 100 in a seventh modified example of the first embodiment differs from that of the first embodiment in that the application processor 400 embeds the digital watermark information before compression processing.

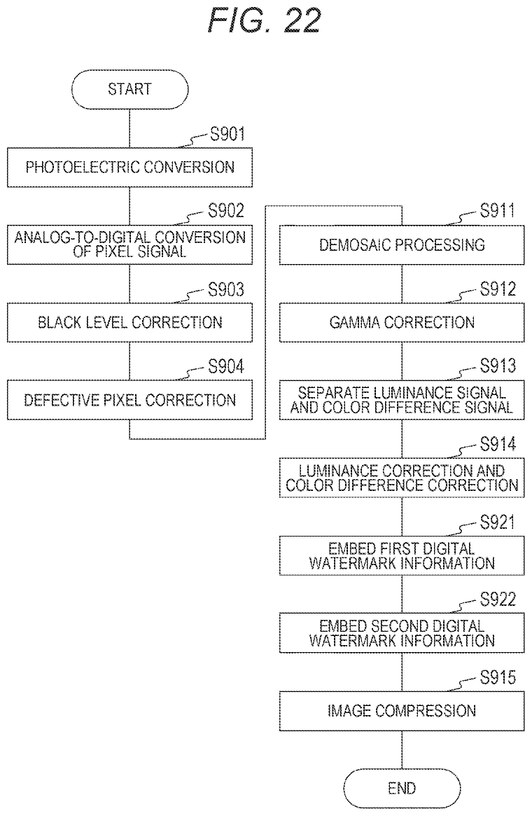

FIG. 22 is a flowchart illustrating an example of the operation of the electronic device 100 according to the seventh modified example of the first embodiment of the present technology. In the electronic device 100 in the seventh modified example of the first embodiment, the application processor 400 embeds the digital watermark information (steps S921 and S922) before compression processing, for example, after correction of the luminance components and the color difference components (step S914).

As illustrated in the drawing, the application processor 400 embeds the second digital watermark information WM2 before compression processing, and this allows the server 500 to determine whether there has been an act of falsification before the compression processing.

As described above, according to the seventh modified example of the first embodiment of the present technology, the application processor 400 embeds the second digital watermark information WM2 before compression processing, and this makes it possible to determine whether there has been an act of falsification before the compression processing.

### EIGHTH MODIFIED EXAMPLE

In the first embodiment described above, the imaging device 200 embeds the first digital watermark information WM1 before demosaic. Alternatively, it is possible to embed the first digital watermark information WM1 after the demosaic. The electronic device 100 in an eighth modified example of the first embodiment differs from that of the first embodiment in that the application processor 400 embeds the first digital watermark information WM1 after demosaic.

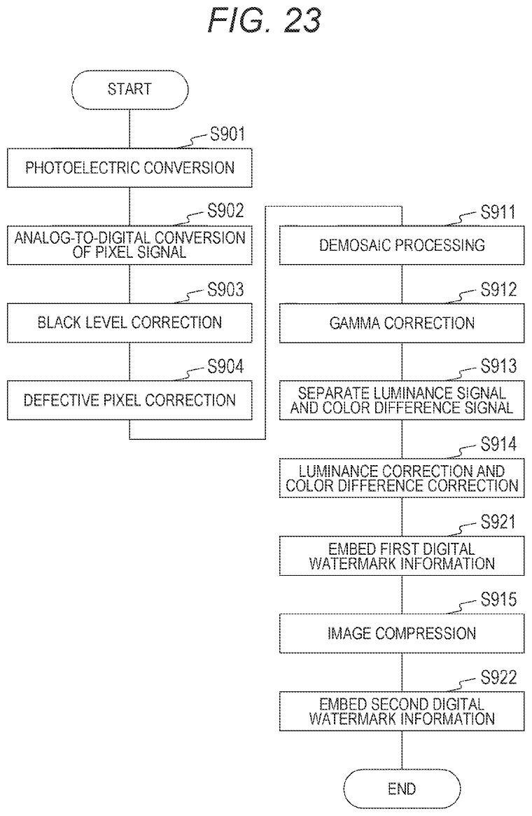

FIG. 23 is a flowchart illustrating an example of the operation of the electronic device 100 according to the eighth modified example of the first embodiment of the present technology. In the electronic device 100 in the eighth modified example of the first embodiment, the application processor 400 embeds the first digital watermark information WM1 (step S921) before compression processing, for example, after correction of the luminance components and the color difference components (step S914).

As illustrated in the drawing, the application processor 400 embeds the first digital watermark information WM1 after demosaic processing, and this allows for protection of the copyright of the image after the demosaic processing by a spoofing determination by the server 500.

As described above, according to the eighth modified example of the first embodiment of the present technology, the application processor 400 embeds the first digital watermark information WM1 after demosaic processing, and this allows for protection of the copyright of the image after the demosaic processing.

### NINTH MODIFIED EXAMPLE

In the first embodiment described above, the imaging device 200 embeds the first digital watermark information WM1 before compression processing. Alternatively, the first digital watermark information WM1 can be embedded after the compression processing. The electronic device 100 in a ninth modified example of the first embodiment differs from that of the first embodiment in that the application processor 400 embeds the first digital watermark information WM1 after compression processing.

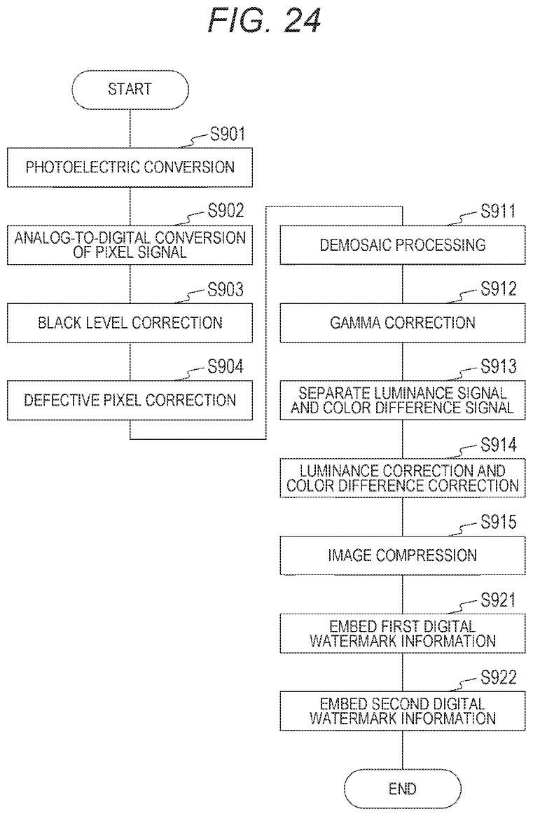

FIG. 24 is a flowchart illustrating an example of the operation of the electronic device 100 according to the ninth modified example of the first embodiment of the present technology. The operation of the electronic device 100 in the ninth modified example of the first embodiment differs from that of the first embodiment in that the application processor 400 embeds the first digital watermark information WM1 (step S921) after image compression (step S915).

As illustrated in the drawing, the application processor 400 embeds the first digital watermark information WM1 after compression processing, and this allows for protection of the copyright of the image after the compression processing by a spoofing determination by the server 500.

As described above, according to the ninth modified example of the first embodiment of the present technology, the application processor 400 embeds the first digital watermark information WM1 after compression processing, and this allows for protection of the copyright of the image after the compression processing.

### 2. Second Embodiment

In the first embodiment described above, the application processor 400 embeds the digital watermark information, and there is a possibility that this configuration may not allow for sufficient improvement of the security. An application processor 400 of a second embodiment differs from that of the first embodiment in that information related to a digital signature is embedded instead of digital watermark information for improvement of security.

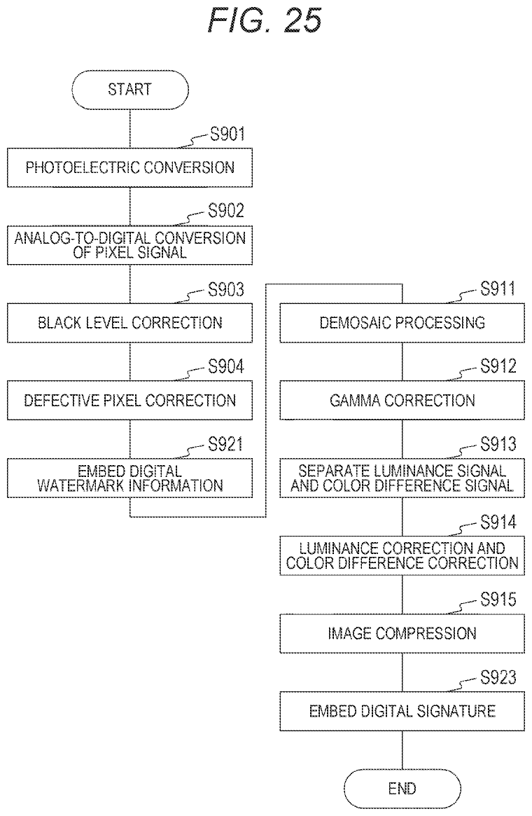

FIG. 25 is a flowchart illustrating an example of operation of an electronic device 100 according to the second embodiment of the present technology. The operation of the electronic device 100 of the second embodiment differs from that of the first embodiment in that the application processor 400 embeds a digital signature (step S923) instead of digital watermark information. This digital signature is a type of steganography described previously.

For example, the application processor 400 uses a hash function to generate a message digest from a message M2, and encrypts the message digest with a private key to obtain a digital signature. Then, the application processor 400 embeds information related to the digital signature in a compressed watermark image IMG2′ (step S923). A server 500 generates a message digest from received data by using the hash function, and also generates a message digest from the digital signature by using a public key, and then compares them. Such an encryption method is called public key cryptography. Note that, in a case where a digital signature is embedded, the electronic device 110 can further embed information related to the digital signature (encryption scheme or the like) together with a first digital watermark information WM1.

Note that the application processor 400, which embeds a digital signature in image data, is capable of embedding a digital signature in non-image data. Furthermore, any of the first modified example to the ninth modified example of the first embodiment can be applied to the second embodiment.

Note that the information related to the digital signature is an example of the second embedded information in the claims.

As illustrated in the drawing, the application processor 400 can embed an encrypted digital signature to ensure confidentiality of communication. This improves security of a communication system.

As described above, according to the second embodiment of the present technology, the application processor 400 embeds the digital signature in the content, and this improves the security of the communication system.

Note that the above-described embodiments show examples for embodying the present technology, and the matters in the embodiments correspond to the matters specifying the invention in the claims. Similarly, the matters specifying the invention in the claims correspond to the matters in the embodiments of the present technology having the same names. However, the present technology is not limited to the embodiments, and can be embodied by making a wide variety of modifications to the embodiments without departing from the gist thereof.

Furthermore, the processing procedures described in the above-described embodiments may be regarded as a method including a series of these procedures, or may be regarded as a program for causing a computer to execute the series of these procedures or a recording medium that stores the program. As the recording medium, for example, a compact disc (CD), a MiniDisc (MD), a digital versatile disc (DVD), a memory card, a Blu-ray (registered trademark) disc, or the like can be used.

Note that the effects described herein are merely illustrative and are not intended to be restrictive, and other effects may be obtained.

Note that the present technology can also be configured as described below.

(1) An electronic device including:

a content generation unit that generates content;

a first embedding processing unit that embeds, in the content, first embedded information related to the content; and

second embedding processing that embeds second embedded information in the content.

(2) The electronic device according to (1), in which

the first embedded information and the second embedded information are digital watermark information.

(3) The electronic device according to (2), in which

the first embedded information and the second embedded information differ in robustness.

(4) The electronic device according to (3), in which

the robustness of the first embedded information is higher than the robustness of the second embedded information.

(5) The electronic device according to (4), in which

the second embedding processing unit embeds the second embedded information in the content in which the first embedded information has been embedded.

(6) The electronic device according to (4) or (5), further including:

an image processing unit that executes predetermined image processing on the content in which the first embedded information has been embedded,

in which the second embedding processing unit embeds the second embedded information in the content on which the image processing has been executed.

(7) The electronic device according to (6), in which

the content is image data, and

the image processing includes demosaic processing.

(8) The electronic device according to (6) or (7), in which

the image processing includes compression processing.

(9) The electronic device according to any one of (4) to (8), in which

the first embedded information is robust digital watermark information or semi-fragile digital watermark information, and the second embedded information is semi-fragile digital watermark information or fragile digital watermark information.

(10) The electronic device according to any one of (6) to (9), in which

the content is image data that includes a first pixel region and a second pixel region,

the first embedded information is embedded in the first pixel region,

the second embedded information is embedded in a region corresponding to the second pixel region in the image data after the image processing, and

the first pixel region and the second pixel region do not overlap.

(11) The electronic device according to (10), in which

the image processing includes compression processing.

(12) The electronic device according to any one of (6) to (9), in which

the content is image data that includes a first pixel region and a second pixel region,

the first embedded information is embedded in the first pixel region,

the second embedded information is embedded in a region corresponding to the second pixel region in the image data after the image processing, and

the first pixel region and the second pixel region at least partially overlap.

(13) The electronic device according to (12), in which

the image processing includes compression processing.

(14) The electronic device according to (13), in which

the first embedded information includes information related to the second embedded information.

(15) The electronic device according to (1), in which

the second embedded information is encrypted non-digital watermark information.

(16) The electronic device according to (15), in which

the content is an image file that includes image data and non-image data, and

the second embedded information is embedded in the non-image data.

(17) The electronic device according to (16), in which

the second embedded information is information related to a digital signature.

(18) The electronic device according to any one of (1) to (17), in which

the first embedded information includes information related to the second embedded information.

(19) The electronic device according to any one of (1) to (18), in which

the second embedded information includes information related to the first embedded information.

(20) The electronic device according to any one of (1) to (19), in which

the first embedded information includes copyright information.

### REFERENCE SIGNS LIST

100 Electronic device
110 Recording unit
120 Data processing unit
200 Imaging device
210 Signal processing unit
211 Clamp unit
212 Defect correction unit
213 Shading correction unit
220 First digital watermark information embedding unit
230 First digital watermark information creation unit
231 One-bit divider
232 Pseudo-random number generator
233 Selector
234, 241 Adder
240, 451 Digital watermark embedding unit
242 Value limiting unit
250, 411, 422, 520 Interface
300 Imaging element
310 Vertical scanning circuit
320 Pixel array unit
330 Pixel
331 Photodiode
332 Transfer transistor
333 Reset transistor
334 Floating diffusion layer
335 Amplifying transistor
336 Selection transistor
340 Constant current source circuit
341 Load MOS
350 Timing control unit
360 Column analog-to-digital conversion unit
361 ADC
370 Reference signal generation unit
371 DAC
380 Horizontal scanning circuit
391 Semiconductor substrate
392 Color filter
393 On-chip lens
400 Application processor
412 White balance correction unit
413 Noise suppression unit
414 Demosaic unit
415 Linear matrix correction unit
416 Gamma correction unit
417 Luminance/color-difference separation unit
418 Luminance correction unit
419 Color difference thinning unit
420 Color difference correction unit
421 Image compression unit
450 Second digital watermark information embedding unit
452, 510 Digital watermark information reading unit
460 Second digital watermark information creation unit
461 Image-related data two-halves divider
462 Message authentication code generator
463 Subtractor
464 Image-related data combiner
500 Server
530 Spoofing determination unit
540 Falsification determination unit
550 Database

1. An electronic device comprising:
a content generation unit that generates content;
a first embedding processing unit that embeds, in the content, first embedded information related to the content; and
second embedding processing that embeds second embedded information in the content.

2. The electronic device according to claim 1, wherein
the first embedded information and the second embedded information are digital watermark information.

3. The electronic device according to claim 2, wherein
the first embedded information and the second embedded information differ in robustness.

4. The electronic device according to claim 3, wherein
the robustness of the first embedded information is higher than the robustness of the second embedded information.

5. The electronic device according to claim 4, wherein
the second embedding processing unit embeds the second embedded information in the content in which the first embedded information has been embedded.

6. The electronic device according to claim 4, further comprising:
an image processing unit that executes predetermined image processing on the content in which the first embedded information has been embedded,
wherein the second embedding processing unit embeds the second embedded information in the content on which the image processing has been executed.

7. The electronic device according to claim 6, wherein
the content is image data, and
the image processing includes demosaic processing.

8. The electronic device according to claim 6, wherein
the image processing includes compression processing.

9. The electronic device according to claim 4, wherein
the first embedded information is robust digital watermark information or semi-fragile digital watermark information, and the second embedded information is semi-fragile digital watermark information or fragile digital watermark information.

10. The electronic device according to claim 6, wherein
the content is image data that includes a first pixel region and a second pixel region,
the first embedded information is embedded in the first pixel region,
the second embedded information is embedded in a region corresponding to the second pixel region in the image data after the image processing, and
the first pixel region and the second pixel region do not overlap.

11. The electronic device according to claim 10, wherein
the image processing includes compression processing.

12. The electronic device according to claim 6, wherein
the content is image data that includes a first pixel region and a second pixel region,
the first embedded information is embedded in the first pixel region,
the second embedded information is embedded in a region corresponding to the second pixel region in the image data after the image processing, and
the first pixel region and the second pixel region at least partially overlap.

13. The electronic device according to claim 12, wherein
the image processing includes compression processing.

14. The electronic device according to claim 13, wherein
the first embedded information includes information related to the second embedded information.

15. The electronic device according to claim 1, wherein
the second embedded information is encrypted non-digital watermark information.

16. The electronic device according to claim 15, wherein
the content is an image file that includes image data and non-image data, and
the second embedded information is embedded in the non-image data.

17. The electronic device according to claim 16, wherein
the second embedded information is information related to a digital signature.

18. The electronic device according to claim 1, wherein
the first embedded information includes information related to the second embedded information.

19. The electronic device according to claim 1, wherein
the second embedded information includes information related to the first embedded information.

20. The electronic device according to claim 1, wherein
the first embedded information includes copyright information.
